(19) United States
(12) Patent Application Publication
(10) Pub. No.: US 2012/0250707 A1
(43) Pub. Date: Oct. 4, 2012

(54) STABILIZATION OF PULSED MODE SEED LASERS

(75) Inventors: Fuyuan Lu, Beijing (CN); Feng Chang, Beijing (CN); Haisheng Wu, Beijing (CN); Yunlong Sun, Portland, OR (US)

(73) Assignee: Electro Scientific Industries, Inc., Portland, OR (US)

(21) Appl. No.: 13/076,970

(22) Filed: Mar. 31, 2011

(51) Int. Cl. H01S 3/10

(52) U.S. Cl. 372/25

(57) ABSTRACT

A programmable tailored laser pulse generator including a pulsed seed laser source, a laser amplifier, and an optical power amplifier produces high power tailored laser pulses shaped in response to a programmable analog tailored pulse signal applied to a seed laser (first embodiment) or an external modulator of continuous-wave seed laser output (second embodiment). The programmable analog tailored pulse signal is generated by combining multiple individually programmable analog pulses generated by a multi-channel signal generator. A bias applied to the pulsed seed laser source generates pre-lasing prior to producing a tailored laser pulse so that the seed laser source spectral line and line width stabilize within a narrow gain line width of a solid-state laser amplifier, thereby to impart pulse peak stability of the laser output. The tailored laser pulse generator allows for generating harmonics at shorter wavelengths and provides an economical, reliable laser source for a variety of micromachining applications.

### COPYRIGHT NOTICE

© 2011 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure relates to generating tailored laser pulses for use in laser micromachining applications and, in particular, to methods and systems employing a highly efficient programmable tailored laser pulse generator that emits tailored laser pulses developed by a seed laser in response to programmable electrical signal pulses and amplified by a fiber laser and solid-state power amplifier.

### BACKGROUND INFORMATION

Memory chip redundant link processing is one example of a laser micromachining application. After manufacture of a semiconductor memory array chip is complete, integrated circuit (IC) patterns on an exposed surface of the chip are sealed with an electrically insulating layer of passivating material. Typical passivating materials include resins or thermoplastic polymers such as, for example, polyimide. The purpose of this final “passivation” layer is to prevent the surface of the chip from reacting chemically with ambient moisture, to protect the surface from environmental particulates, and to absorb mechanical stress. Following passivation, the chip is mounted in an electronic package embedded with metal interconnects that allow probing and functional testing of the memory cells. When one of many redundant memory cells is determined to be faulty, the cell is disabled by severing the conductive interconnects, or wires, linking that cell to its neighbors in the array. Disabling individual memory cells by “link processing” or “link blowing” is accomplished by laser micromachining equipment that is capable of directing laser beam energy so as to selectively remove the link material in a highly localized region without imparting damage to the materials adjacent to, below, or above the target. Selectively processing a designated link may be achieved by varying the laser beam wavelength, spot size, pulse repetition rate, pulse shape, or other spatial or temporal beam parameters that influence energy delivery.

Laser micromachining processes that entail post-processing of conductive links in memory arrays or other types of IC chips use sharp pulses with a fast rising front edge (e.g., with a 1-2 ns rise time) to achieve desired quality, yield, and reliability. To cleanly sever a conductive link, the laser pulse penetrates the overlying passivation layer before cutting through the metal interconnect. The rising edge of a typical pulse from an existing solid-state laser varies with pulse width. Use of a traditional Gaussian-shaped laser pulse having a 5-20 ns pulse width and a sloped, gradually rising front edge in link processing tends to cause an “over crater” in the passivation layer, especially if its thickness is too large or is uneven.

Rupture behavior of overlying passivation layers has been well analyzed by Yunlong Sun in his PhD dissertation entitled, “Laser processing optimization of semiconductor based devices” (Oregon Graduate Institute, 1997). Because passivation layer thickness is an important parameter, the optimal thickness of a particular passivation layer material may be determined by simulations based on Sun's analysis. Difficulty in maintaining wafer-level process control of the passivation layer during IC fabrication may result in non-optimal thickness and poor cross-wafer or wafer-to-wafer thickness uniformity. Therefore, optimizing characteristics of laser pulses used in post-processing may help to compensate for mis-targeted dimensions and sources of variation in the passivation layer.

U.S. Pat. No. 6,281,471 of Smart proposes using substantially square-shaped laser pulses for link processing. Such a sharp-edged pulse may be generated by coupling a master oscillator laser with a fiber power amplifier. This configuration is typically referred to as a master oscillator power amplifier configuration (MOPA), or MOFPA in the case of a fiber power amplifier. This low power master oscillator typically employs a diode laser that is capable of generating a square-shaped pulse with a fast rise time. On the other hand, in U.S. Pat. No. 7,348,516 of Yunlong Sun et al. (Sun '516) for Methods of and Laser Systems For Link Processing Using Laser Pulses With Specially Tailored Power Profiles, which patent is assigned to the assignee of this patent application, states that, despite a vertical rising edge, a substantially square-shaped laser pulse is not the best laser pulse shape for link processing. Instead, Sun '516 describes use of a specially tailored laser pulse shape that, in one embodiment, resembles a chair, with a fast rising peak or multiple peaks to most effectively process links, followed by a drop-off in signal strength that remains relatively flat at a lower power level before shutting off.

Tailored laser pulse shapes are advantageous compared with fixed Gaussian pulse shapes because, during link processing and other laser processing applications, the tailored laser pulse interacts with the target material or structure with a desired and controllable intensity. The tailored laser pulse provides superior processing results because the intensity is controllable for different processing phases of the target material or different materials in multi-layer target structures.

A typical tailored laser pulse power profile of practical importance in memory link processing is shown in FIG. 1A. The tailored laser pulse power profile of FIG. 1A exhibits (1) a fast rising edge, reaching peak power in less than 1.5 ns; (2) one peak in a selectable time location of the laser pulse temporal profile; and (3) an average minimum power below the peak power. FIG. 1B shows one pulse peak occurring near the center of the laser pulse temporal profile, and FIG. 1C shows multiple pulse peaks occurring at different times in the laser pulse temporal profile. U.S. Pat. No. 7,126,746 of Sun, et al. for Generating Sets of Tailored Laser Pulses describes a memory link processing technique that uses a tailored laser pulse or sets of tailored laser pulses of the types shown in FIGS. 1A, 1B, and 1C.

U.S. Pat. No. 7,289,549 for Lasers for Synchronized Pulse Shape Tailoring and U.S. Pat. No. 7,301,981 for Methods For Synchronized Pulse Shape Tailoring, both by Sun, et al. propose a laser design implemented with two lasing mediums in two optical paths of different lengths to generate a combined laser pulse with a few special tailored laser shapes.

As laser technology has advanced, designs with various pulse-mode seed laser sources followed by fiber amplifiers have become common. One such design is disclosed in U.S. Patent Application Pub. No. 2009/0323741 A1 of Deladurantaye et al. for Digital Laser Pulse Shaping Module and System (Deladurantaye Pub. '741). Deladurantaye Pub. '741 describes a method of using a high speed digital-to-analog converter (DAC) to generate electrical current pulses with the desired pulse shape for either driving an optical modulator coupled to a laser source or driving a laser source directly with the DAC by injecting the desired tailored pulse shape into the laser source.

According to one embodiment described in Deladurantaye Pub. '741, when a driving current pulse drives an optical gating device or modulator, a single continuous-wave diode laser forms a master oscillator and its output is coupled to the optical modulator, such as an electro-optical (E-O) device or a Mach-Zehnder modulator to form a specially tailored pulse. The tailored pulse is then delivered to a fiber preamplifier, the output of which is applied to a fiber power amplifier in a MOPA configuration. As an option, a harmonic converter can be added to convert the wavelength of the output laser beam.

A MOPA configuration provides a stable signal source, pulse shape, and laser beam quality but is limited by a lower laser power output level. A fiber amplifier finds frequent use because of its high gain and ease in optical pumping and integration into optical system structures. However, higher-power (i.e., two-watts or greater) MOPA link-processing systems in the green or ultraviolet spectrum carry a high risk of damage to the fiber power amplifier, which receives for amplification high power IR laser energy used in the conversion to green or UV light. Using a fiber power amplifier to obtain the power levels needed for link processing and other laser processing applications requiring higher power has proven to be extremely difficult with current fiber laser technology. As higher laser power is needed for processing applications, the fiber amplifier becomes a system-limiting design factor.

U.S. Pat. No. 7,796,655 of Murison et al., assigned to ESI-PyroPhotonics Lasers Inc., discloses a method of using a continuous-wave seed diode laser and an amplitude modulator in an optical circulator to form a tailored pulse optical waveform. Both Deladurantaye Pub. '741 and Murison et al. describe use of a modulator to form a specially tailored pulse in which the shape of the waveform used to drive the modulator originates from a digital pattern stored in memory on a DAC. Deladurantaye Pub. '741 also describes use of a DAC to drive directly a seed diode laser to generate a tailored pulse suitable for amplification. In this configuration, the output from the seed diode laser exhibits the desired special tailored shape and can be amplified directly without further modulation. The Deladurantaye Pub. '741 does not discuss spectrum stability of the seed laser output.

A disadvantage of using a DAC to generate electrical current pulses with the desired pulse shape is that the electronic circuitry is complex to design. The DAC must divide the tailored pulse into many consecutive divisions or segments. The greater the number of segments the DAC produces, the better the resolution the tailored pulse signal will be. Pulse timing resolution and speed of the DAC are dictated also by an operating requirement that a typical tailored pulse profile have a leading-edge rise time of less than 1.5 ns to provide a link-processing benefit over the traditional Gaussian shaped pulse. This leading-edge rise time specifies a pulse timing resolution of 1 ns (or less), i.e., the duration of each DAC segment is at most 1 ns. A tailored pulse with this pulse timing resolution and speed and a total pulse duration of 50 to 100 ns requires that the DAC have as many as 50 to 100 segments. Thus, the speed of the DAC and its control logic must be faster than 1 GHz. The DAC speed and number of segments required for the tailored pulse generation make the DAC implementation a challenge to design.

### SUMMARY OF THE DISCLOSURE

A programmable tailored laser pulse generator generates seed laser output in response to an electrical signal of programmable pulse shape to produce tailored laser pulses of a prescribed shape with pulse widths on the order of sub-nanosecond to hundreds of nanoseconds and fast rise times on the order of a few nanoseconds to sub-nanosecond. A first preferred tailored laser pulse generator embodiment includes a pulsed laser source in the form of a pulsed seed laser that has as its input an electrical signal to produce pulsed seed laser output. A second preferred tailored laser pulse generator embodiment includes a modulator that is positioned external to and receives output emissions from a continuous-wave seed laser to produce pulsed seed laser output. The tailored laser pulse generator produces a series of high power tailored laser pulses that are shaped in response to the electrical signal applied to the pulsed seed laser (first embodiment) or the external modulator (second embodiment) and by optical power amplifiers. The tailored laser pulse generator allows for power-scaling and generating harmonics at shorter wavelengths and provides an economical, reliable laser source that is capable of operating at high repetition rates. The tailored laser pulse generator produces tailored laser pulses at a variety of wavelengths for a variety of laser processing tasks, including laser marking, laser via and hole drilling, laser welding, dicing, scribing, cutting, and other laser processing applications for various metal and non-metal materials, including solar cells, flat panels, or other substrates. The combinatorial scheme implemented by the tailored laser pulse generator is inherently more efficient than existing subtractive methods that form a tailored laser pulse by optically slicing a seed pulse. Furthermore, the scheme produces stable laser output power developed from a solid-state amplifier and thereby provides laser power scalability.

Additional aspects and advantages will be apparent from the following detailed description of preferred embodiments, which proceeds with reference to the accompanying drawings.

### BRIEF DESCRIPTION OF THE DRAWINGS

FIGS. 1A, 1B, and 1C are three examples of tailored pulse shapes suitable for laser link processing.

FIG. 2 is a block diagram of a first preferred embodiment of a programmable tailored laser pulse generator of the present disclosure.

FIG. 3 is a diagram demonstrating the synthesis of a preferred current drive profile of a tailored drive current pulse input signal, according to one embodiment.

FIG. 4 is a block diagram of two laser driver integrated circuit chips interconnected to establish a bias current and the tailored drive current pulse input signal of FIG. 3, line D.

FIG. 5 is a gain spectrum of a typical solid-state gain element, Yb:YVO₄, illustrating amplification gain versus spectral wavelength of a solid-state amplifier.

FIGS. 6A and 6B are renderings of a chair-type tailored laser pulse output representing outputs of a solid-state amplifier exhibiting, respectively, poor peak stability before and improved peak stability after applying a bias to the seed laser shown in FIGS. 2 and 7.

FIG. 7 is block diagram of a second preferred embodiment of a programmable tailored laser pulse generator of the present disclosure.

### DETAILED DESCRIPTION OF PREFERRED EMBODIMENTS

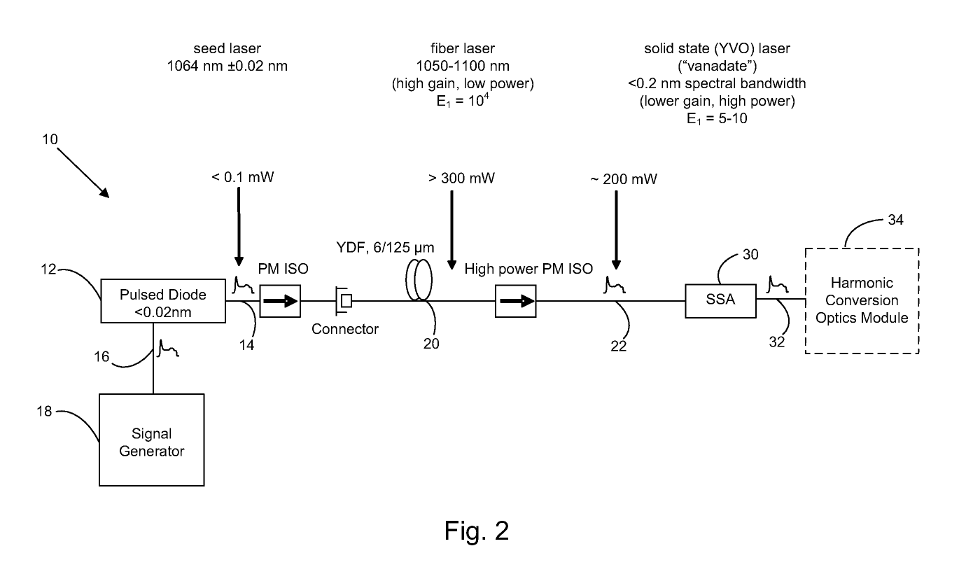

With reference to FIG. 2, in a first preferred embodiment, a programmable tailored laser pulse generator 10 includes a pulse-pumped seed diode laser 12 to produce pulsed seed laser output 14 having a laser pulse intensity profile developed in response to a tailored drive current pulse input signal 16 synthesized by a multiple channel analog signal generator 18. The spectral line width and spectral line stability of pulsed seed laser output 14 are important factors for laser processing applications, such as memory chip link severing, but are also important characteristics for developing stable amplification by solid-state laser amplifiers. Seed diode laser 12 having a stable spectral line and narrow spectral line width provides a focused laser spot size that is sufficiently small to meet laser processing needs. An example of a preferred seed diode laser 12 is a 1064 nm Single Mode Spectrum Stabilized Laser Model No. 11064SB0120P, available from Innovative Photonic Solutions, Inc., Monmouth Junction, N.J. This laser is specifically designed for seeding high peak power pulsed fiber lasers and has a specified spectral bandwidth of ±0.02 nm at 1064 nm. It employs a Bragg grating optical filter to achieve the narrow line width of 1 MHz and stability of 0.007 nm per degree Celsius. In an alternative embodiment, the seed diode laser 12 is a seed fiber laser.

Analog signal generator 18 creates on multiple channels programmed analog current pulses that are combined to form tailored drive current pulse input signal 16. An example of a preferred analog signal generator 18 is a Model iC-HB Triple 155 MHz laser driver, available from iC Haus, Bodenheim, Germany. The iC-HB driver is an integrated circuit that provides three-channel analog signal generating capability, in which each channel produces an electrical current pulse that is independently programmed to a user-specified amplitude, pulse width, and timing parameters, including a fast leading edge rise time of less than 1.5 ns. The delay times separating the three-channel pulses are programmed by triggering them at the times desired. Tailored drive current pulse input signal 16 is formed by combination of the three programmable channel current pulses. Multiple iC-HB drivers can be interconnected to expand the number of programmable channel current pulses of which signal generator 18 is capable of providing. Analog signal generator 18 may be programmed to synthesize tailored drive current pulse input signal 16 having a drive current profile that assumes any one of a number of pulse shapes.

Pulsed seed laser output 14 seeds a fiber laser amplifier 20, which is implemented in one or more amplifier stages to operate in a 1050-1100 nm range at high gain (e.g., 10⁴) and low power to produce amplified laser output 22 that is delivered to a solid-state amplifier 30. Amplified laser output 22 exhibits the same spectral line and spectral line width characteristics as those of pulsed seed laser output 14, which is applied as the input signal to fiber laser amplifier 20. One preferred embodiment of fiber laser amplifier 20 is a Single Mode Ytterbium Doped Fiber Model No. LIEKKI Yb1200-6/125, available from nLIGHT Corporation, Vancouver, Wash. Skilled persons will recognize that the length of the fiber, type of lasing dopant, doping level, and pumping level can be selected to realize the required amplification gain. Solid-state amplifier 30 implemented in one or more amplifier stages produces high power laser output 32 that exhibits an ultra-narrow spectral bandwidth at its operating wavelength. An example of a preferred solid-state amplifier 30 is a vanadate (YVO) laser. The vanadate gain medium has an emission wavelength of 1064 nm and a gain spectral width of less than 0.02 nm. The solid-state amplifier gain element is selected preferably from a variety of well-known Yb- or Nd-doped solid-state lasants, most preferably Yb:YVO₄ or Nd:YAG, which may be in the form of a rod, cylinder, disk, or rectangular parallelepiped.

High power laser output 32 may optionally be applied to a harmonic conversion optics module 34, such as a second harmonic generator to generate green light output. Harmonic conversion module 34 incorporates nonlinear crystals for the conversion of an incident input pulse to a higher harmonic frequency through well-known harmonic conversion techniques. In a first embodiment implementing harmonic conversion of high power laser output 32 from 1064 nm to 355 nm, harmonic conversion optics module 34 incorporates Type I non-critically phase-matched lithium triborate (LBO) crystal for second harmonic generation (SHG) conversion followed by a Type I critically phase-matched lithium borate for third harmonic generation (THG) conversion. In a second embodiment implementing harmonic conversion to 266 nm, the THG LBO crystal may be replaced by a critically phase-matched beta-barium borate (BBO) crystal. In a third embodiment implementing FHG conversion to 266 nm, CLBO may be alternatively employed. Harmonic conversion processes are described in V. G. Dmitriev, et al., Handbook of Nonlinear Optical Crystals, 138-141, Springer-Verlag, New York, 1991 ISBN 3-540-53547-0.

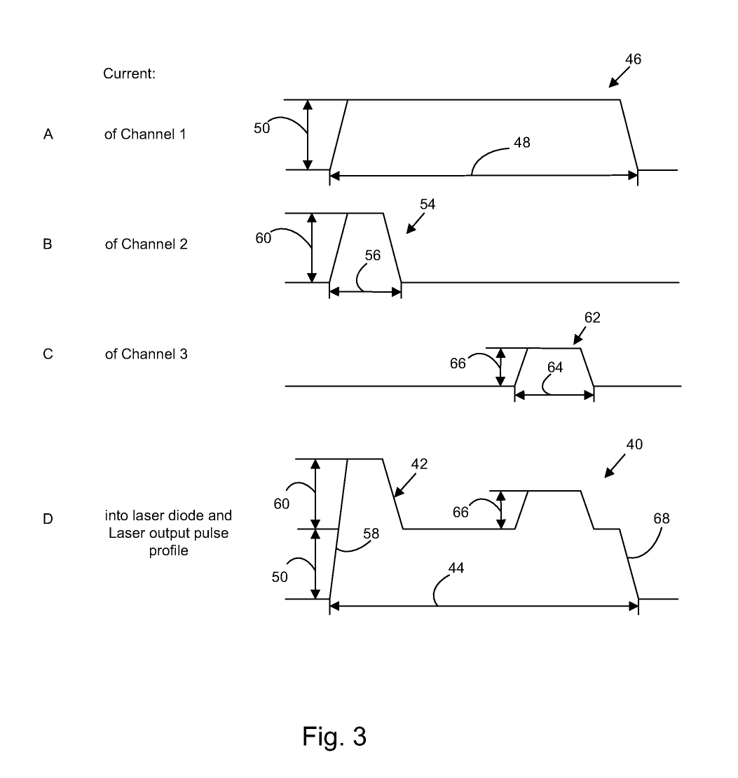

FIG. 3 is a diagram demonstrating the synthesis of a preferred current drive profile 40 of tailored drive current pulse input signal 16. Current drive profile 40, which is shown at FIG. 3, line D, as having a time varying amplitude 42 over a pulse period 44, represents the superposition of three electrical current waveforms. FIG. 3, line A, shows the electrical current waveform of a channel 1 pulse 46, which is a square pulse with a pulse width 48 that spans the pulse period of drive current profile 40. An amplitude 50 and pulse width 48 of pulse 46 establish the average minimum power of the laser pulse intensity profile of pulsed seed laser output 14. FIG. 3, line B, shows the electrical current waveform of a channel 2 pulse 54, which is a square pulse with a narrow pulse width 56 that contributes a current spike starting at a leading edge 58 of drive current profile 40. An amplitude 60 and pulse width 56 of pulse 54 establish, respectively, the peak amplitude and duration of an initial power spike of the laser pulse intensity profile of pulsed seed laser output 14. FIG. 3, line C, shows the electrical current waveform of a channel 3 pulse 62, which is a square pulse with a wider pulse width 64 and lower amplitude 66 than, respectively, pulse width 56 and amplitude 60 of channel 2 pulse 54. Channel pulses 54 and 62 are time-displaced by an amount that causes channel 3 pulse 62 to contribute a lower peak amplitude current pulse near a trailing edge 68 of drive current profile 40. Amplitude 66 and pulse width 64 of pulse 62 establish, respectively, the peak amplitude and duration of a comparatively lower power, longer duration target material processing pulse proximal to the trailing edge of the laser pulse intensity profile of pulsed seed laser output 14.

As stated earlier, each iC-HB driver is presently limited to three output channels, although additional channels are contemplated and within the scope of this disclosure. More elaborate tailored current drive profiles, e.g., tailored drive current signal profile 40 of FIG. 3, line D, superimposed on a bias current level for reasons explained below, entail use of additional programmable channels for generating additional, combinable current pulses. This is accomplished by connecting together multiple iC-HB drivers to provide six, nine, or more programmable channels. Additionally, for cases in which a seed diode laser driving current of high magnitude exceeds the maximum current rating of a single iC-HB driver channel, multiple channels can be combined in parallel to cooperatively sink the high magnitude current.

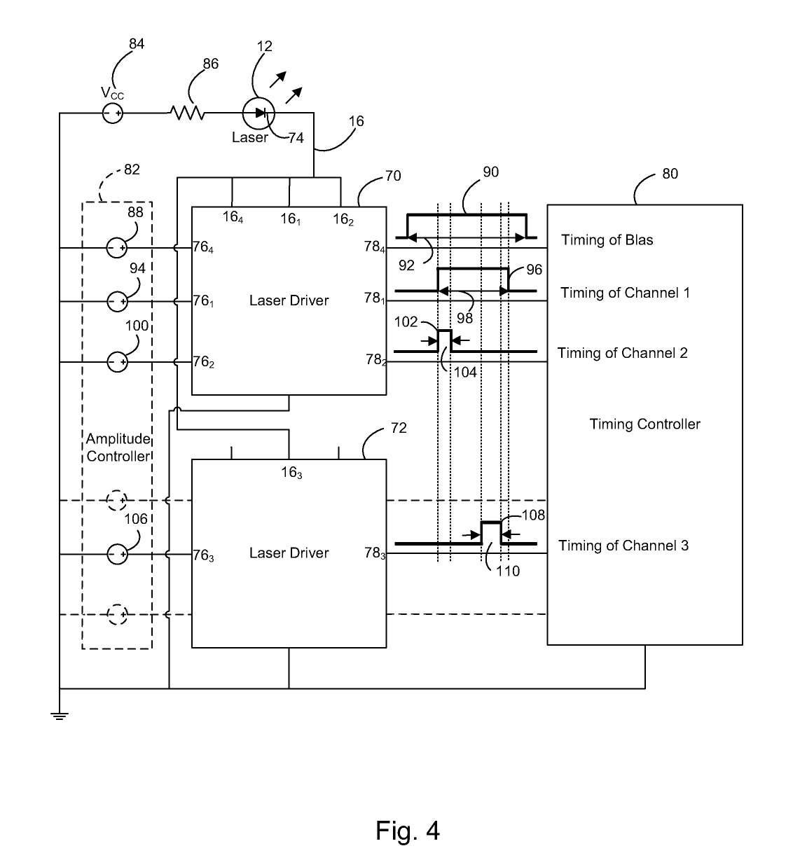

FIG. 4 shows an embodiment with a first iC-HB driver 70 and a second iC-HB driver 72 that are suitable for establishing a bias current and a tailored drive current pulse input signal 16 having current drive profile 40 of FIG. 3, line D. As noted above, each of iC-HB drivers 70 and 72 has three channels, with each channel including a current-control voltage channel input, a switching input, and a diode cathode-current sink. In the embodiment shown in FIG. 4, the diode cathode-current sinks are combined to a cathode 74 of seed diode laser 12, with one channel establishing a bias and three other channels establishing drive current pulse profile 40. Channel 1 on driver 70 includes: current-control voltage channel input 76₁, switching input 78₁, and diode cathode-current sink 16₁. Channel 2 on driver 70 includes: current-control voltage channel input 76₂, switching input 78₂, and diode cathode-current sink 16₂. Channel 3 on driver 72 includes: current-control voltage channel input 76₃, switching input 78₃, and diode cathode-current sink 16₃. Additionally, a bias channel on driver 70 includes: current-control voltage channel input 76₄, switching input 78₄, and diode cathode-current sink 16₄. A timing controller 80 is programmed to establish timing pulses that open and close the switching inputs of drivers 70 and 72. When timing controller 80 activates a timing pulse on a switching input, the switching input opens the corresponding channel diode cathode-current sink, thereby allowing the channel to sink a current pulse with a pulse amplitude pre-established by configurable voltages in amplitude controller 82. When a diode cathode-current sink is open during occurrence of the timing pulse, current flows through seed diode laser 12 from a series-connected voltage source 84 and resistor 86.

FIG. 4 shows on electrical conductors between the switching inputs of drivers 70 and 72 and the outputs of timing controller 80 square pulse timing waveforms establishing a current pulse triggering sequence. First, a configurable voltage 88 pre-establishes a bias pulse current amplitude, and then a square-pulse bias timing waveform 90 having a pulse width 92 exceeding the pulse period of drive current profile 40 activates bias current flow through seed diode laser 12. Second, a configurable voltage 94 pre-establishes pulse amplitude 50, and then a timing waveform 96 having a pulse width 98 corresponding to pulse width 48 triggers channel 1 activating pulse 46 (FIG. 3, line A). Third, a configurable voltage 100 pre-establishes pulse amplitude 60, and then a timing waveform 102 having a pulse width 104 corresponding to pulse width 56 triggers channel 2 activating pulse 54 (FIG. 3, line B). Fourth, a configurable voltage 106 pre-establishes pulse amplitude 66, and then a timing waveform 108 having a pulse width 110 corresponding to pulse width 64 triggers channel 3 activating pulse 62 (FIG. 3, line C).

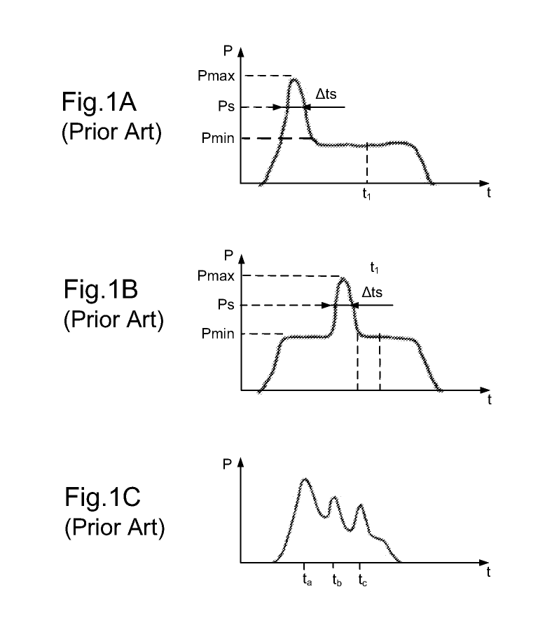

An alternative embodiment uses one iC-HB driver to generate a tailored drive current pulse input signal 16 that is characterized by a single, initial pulse peak and lower average power level with a temporal profile resembling that of the tailored pulse of FIG. 1A. A single channel introduces a bias current level, and the remaining two channels synthesize the initial pulse peak and the lower average power level in a manner similar to that described above with reference to FIG. 4 for driver 70.

There is pulse peak instability of high power laser output 32 of solid-state laser amplifier 30 whenever tailored drive current pulse input signal 16 drives seed diode laser 12 in a pulsed mode with a fast, i.e., less than 1.5 ns, leading edge. After study of this phenomenon, applicants determined that pulse peak instability of laser output 32 is caused by a combination of spectral line instability of pulsed seed laser output 14 while seed diode laser 12 undergoes pulsed pumping and the relatively narrow gain line width of solid-state amplifier 30.

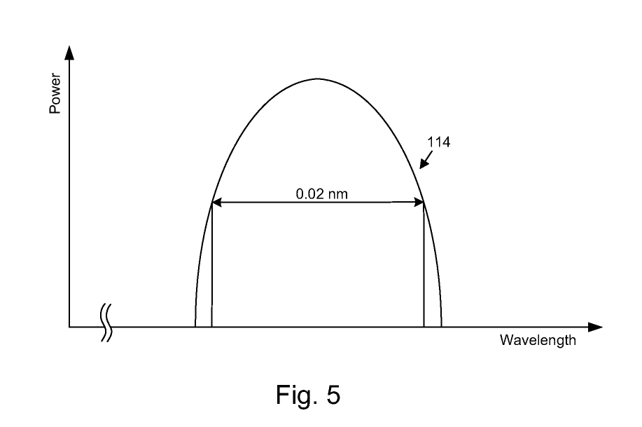

FIG. 5 is a diagram illustrating how such instability at output 32 of solid-state amplifier 30 arises. With reference to FIG. 5, solid-state amplifier 30 has an amplification gain versus spectral wavelength response curve 114. The gain spectral bandwidth at full width, half maximum power is about 0.02 nm. Thus, any fluctuation (instability) of the spectral line or the spectral line width of seed diode laser 12 results in the spectral line of pulsed seed laser output 14 being subject to varying amounts gain along response curve 114, resulting in peak power instability (jitter) of laser output 32. Such pulse peak instability is not apparent at amplified laser output 22 because of the relatively wide (50 nm) spectral bandwidth of the gain medium of fiber laser amplifier 20.

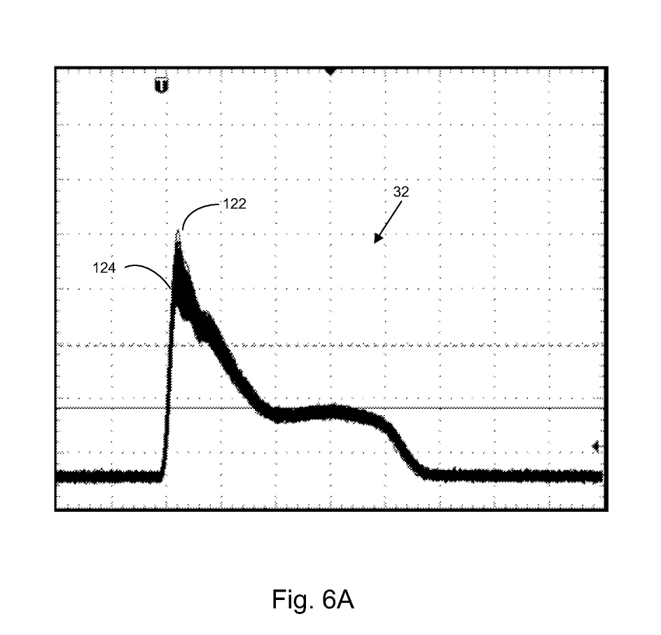

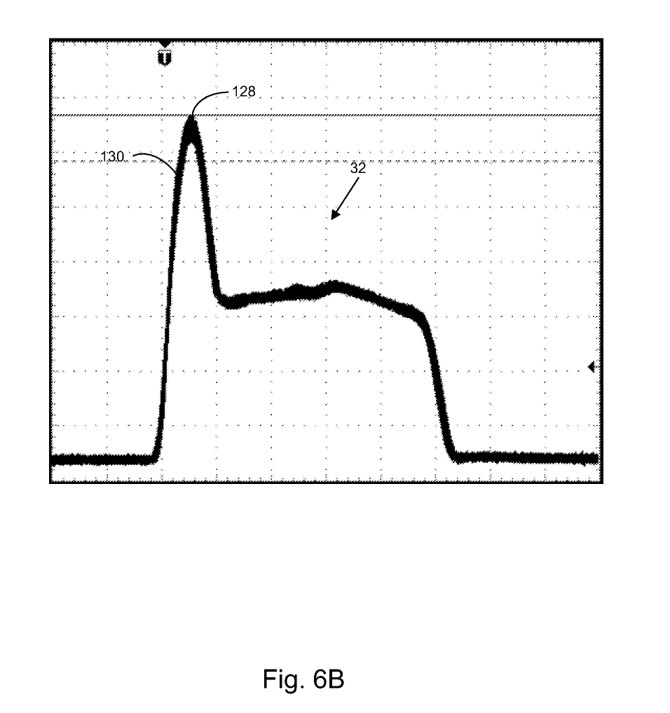

FIG. 6A is an oscilloscope display screenshot rendering of a chair-type tailored pulse representing high power laser output 32 of solid-state amplifier 30. FIG. 6A shows instability of pulse peak 122, at its leading edge 124, of the laser pulse intensity profile of high-power laser output 32. Applicants believe that occurrence of pulse peak instability of laser output 32 is caused by failure of seed diode laser 12 to settle to its specified spectral bandwidth and lasing wavelength stability when stimulated by drive current pulse input signal 16 having a leading edge of less than 1.5 ns. Applicants surmise that seed diode laser manufacturer specifications suggesting otherwise present measurements and performance ratings for continuous-wave operation and, therefore, do not apply to the pulsed laser operating conditions described. A seed diode laser operating in a pulsed mode exhibits laser emission spectral line jitter at the beginning of the pulse before settling to a specified spectrum stability and line width. When seed diode laser 12 is integrated with solid-state amplifier 30, the narrow spectral width of the WO gain medium reveals the instability of the spectral line of seed diode laser 12.

Applicants discovered that applying to seed diode laser 12 a low amplitude bias current pulse starting before and continuing through a portion of the main tailored drive current pulse input signal 16 produces from seed diode laser 12 low power bias lasing, i.e., pre-lasing, that sufficiently stabilizes the spectral line and spectral line width of pulsed seed laser output 14 of seed diode laser 12 and minimizes the previously observable instability of pulse peak 122. FIG. 6B shows the resulting tailored laser output 32 with stable pulse peak power 128. The amplitude of the bias current pulse is sufficiently low to generate from seed diode laser 12 a relatively low pre-lasing output (not shown) such that laser output 32 exhibits excellent pulse peak stability, but the pre-lasing is well below the power level that can be detected after amplification and harmonic generation stages. The main tailored drive current pulse input signal 16 is applied shortly after the start of the low power current bias pulse, so the final laser pulse output 32 from solid-state amplifier 30 can deliver tailored laser pulses without the undesired pulse peak instability. The time delay between the leading edges of the low power current bias pulse and tailored drive current pulse input signal 16 is within a range from a few nanoseconds to a millisecond. The low power current bias pulse partly overlaps main tailored drive current pulse input signal 16 preferably within a range from a few nanoseconds to a millisecond but may extend throughout main tailored drive current pulse input signal 16 (as indicated in FIG. 4). This low amplitude bias current pulse can be generated by one channel of the iC-HB drivers 70 and 72, as discussed below, or by a standalone signal generator.

In the embodiment shown in FIG. 4, the bias channel of driver 70 analog signal generator 18 is used to deliver a low current, wide bias pulse to provide the low power pre-lasing. The preferred bias pulse current level is in the range of 1.0 to 1.2 times of the lasing threshold of seed diode laser 12. A bias current of no higher than 3.0 times the lasing threshold current provides the desired effect. For a preferred embodiment using seed diode laser 12 from Innovative Photonic Solutions, the current is no higher than 46 mA and is preferably in a range of 7 mA to 46 mA. This bias current pulse leads tailored drive current pulse input signal 16 by a preselected time-delay (such as about 10 ns) to allow seed diode laser 12 to stabilize. The bias current reduces from about 16% to about 4% the jitter in pulse peak 122 of laser pulse output 32. FIG. 6B shows the resulting tailored laser pulse output 32 of solid-state amplifier 30 with the desired pulse peak 128 exhibiting stability at its leading edge 130. The bias current level is selected to generate from seed diode laser 12 a much smaller output power than that generated by the tailored drive current pulse input signal 16. Thus, the bias pulse current may overlap in a large part with tailored drive current pulse input signal 16. Optional harmonic converter optics module 34 may be used to reduce the bias laser output component because the nonlinear harmonic conversion process suppresses it.

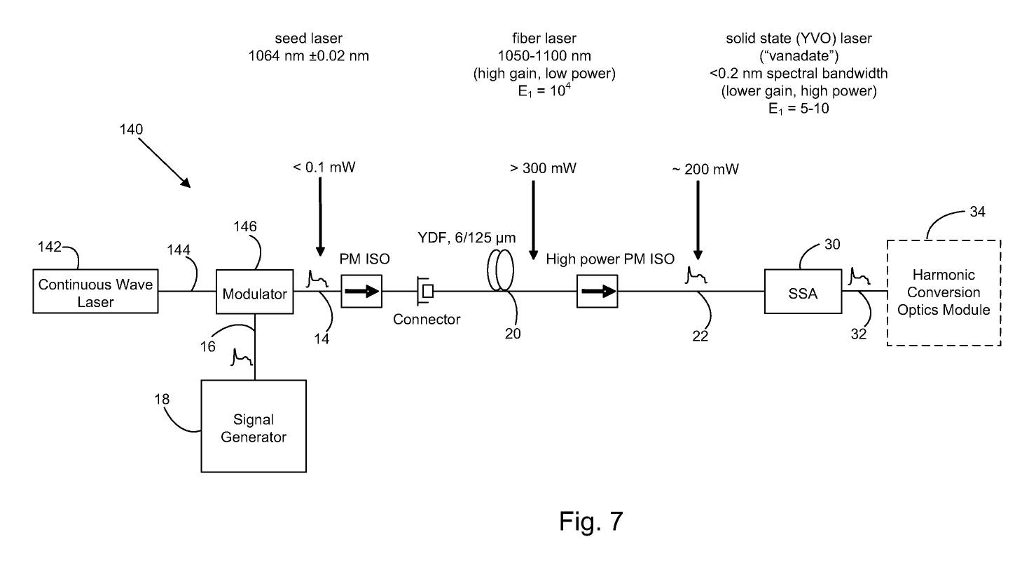

With reference to FIG. 7, in a second preferred embodiment, a programmable tailored laser pulse generator 140 includes continuous-wave seed laser 142 producing continuous-wave laser output 144. An external modulator 146 receives, from seed laser 142, continuous-wave laser output 144 and, from analog signal generator 18, tailored drive current pulse input signal 16 to produce pulsed seed laser output 14. A preferred continuous-wave seed laser is the above-identified seed diode laser from Innovative Photonic Solutions. Alternatively, a continuous-wave single frequency fiber laser described in Murison et al. may be used. External modulator may include an optical modulator such as an E-O device or an APE-type Lithium Niobate Mach-Zehnder modulator having a bandwidth greater than 3 GHz at 1064 nm. The remaining components of pulse generator 140 are the same as those of pulse generator 10 and are, therefore, identified by the same reference numerals.

The terms and descriptions used above are set forth by way of illustration only and are not meant as limitations. Skilled persons will recognize that many variations can be made to the details of the above-described embodiments without departing from the underlying principles of the invention. The scope of the invention should, therefore, be determined only by the following claims.

1. A programmable tailored laser pulse generator emitting pulsed laser output characterized by a time-dependent laser pulse intensity profile, comprising:
a multiple channel analog signal generator producing multiple programmable time-displaced signal pulses that combine to form a tailored pulse analog drive input signal, the signal pulses having amplitudes established so that, in combination, the tailored pulse analog drive input signal exhibits a pulse shape that defines a laser pulse intensity profile;
a pulsed seed laser source operatively associated with the multiple channel analog signal generator and responsive to the tailored pulse analog drive input signal to produce pulsed seed laser output having the laser pulse intensity profile; and
a laser amplifier receiving the pulsed seed laser output and producing amplified laser output having a laser pulse intensity profile corresponding to the laser pulse intensity profile of the pulsed seed laser output.

2. The programmable tailored laser pulse generator of claim 1, in which the pulsed seed laser source includes a seed diode laser.

3. The programmable tailored laser pulse generator of claim 1, in which the pulsed seed laser source includes a seed fiber laser.

4. The programmable tailored laser pulse generator of claim 1, in which the pulsed seed laser source comprises a continuous-wave laser emitting continuous-wave laser output and a pulse modulator cooperating with the continuous-wave laser to modulate the continuous-wave laser output in response to the tailored pulse analog drive input signal to produce the pulsed seed laser output.

5. The programmable tailored laser pulse generator of claim 1, in which the laser amplifier comprises one or more stages of a fiber laser amplifier receiving and amplifying the pulsed seed laser output.

6. The programmable tailored laser pulse generator of claim 1, further comprising one or more stages of a solid-state power amplifier receiving and further amplifying the amplified laser output to produce a power amplifier pulsed laser output.

7. The programmable tailored laser pulse generator of claim 6, in which the pulsed seed laser source is characterized by a spectral line and a spectral line width, and in which the solid-state power amplifier includes a gain medium characterized by a narrow spectral gain width, further comprising a bias source applying to the pulsed seed laser source an electrical bias to establish pre-lasing operation that stabilizes the spectral line and spectral line width within the narrow spectral gain width of the solid-state power amplifier and thereby facilitates stability of the power amplifier pulsed laser output.

8. The programmable tailored laser pulse generator of claim 7, in which one of the multiple programmable time-displaced signal pulses forms the electrical bias, the electrical bias pulse temporally leading and partly overlapping the tailored pulse analog drive input signal and having a current level in a range of 1.0 to 3.0 times a lasing current threshold of the pulsed seed laser source.

9. The programmable tailored laser pulse generator of claim 7, in which the electrical bias is in the form of continuous-wave laser output superimposed on the pulsed seed laser output.

10. The programmable tailored laser pulse generator of claim 6, in which the pulsed seed laser output has a pulsed laser output wavelength, and further comprising a harmonic converter optically associated with the solid-state power amplifier to perform harmonic conversion of the pulsed seed laser output wavelength to generate laser output of a shorter wavelength than the pulsed laser output wavelength.

11. A method of generating programmable pulsed laser output characterized by a programmable time-dependent laser pulse intensity profile, comprising:
producing, from a pulsed seed laser source, pulsed seed laser output having a programmable laser pulse intensity profile developed in response to a drive signal pulse input, the pulsed seed laser source characterized by inferior spectral line and line width stability when operating in a pulsed mode in comparison to that when operating in a continuous-wave mode;
synthesizing the drive signal pulse input having a pulse shape that defines the programmable laser pulse intensity profile;
biasing the pulsed seed laser source with a bias provided for a sufficient duration to stabilize spectral line and spectral line width of the pulsed seed laser source;
providing the drive signal pulse input to the pulsed seed laser source such that it emits pulsed seed laser output at a stabilized spectral line and spectral line width and a stable pulse peak; and
amplifying the pulsed seed laser output with a solid-state power amplifier having a gain medium characterized by a narrow spectral gain width to produce an amplified laser output exhibiting a substantially faithful replication of the pulsed seed laser output at the stabilized spectral line and line width and pulse peak within the narrow spectral gain width of the solid-state power amplifier.

12. The method of claim 11, in which the drive signal pulse input is of an analog type, and in which the synthesis of the drive signal pulse input is performed by a programmable multiple channel analog signal generator producing multiple time-displaced current pulses that combine to form the drive signal pulse input of an analog type.

13. The method of claim 11, in which the pulsed seed laser output has a pulsed laser output wavelength, and further comprising applying the amplified laser output to a harmonic converter to perform harmonic conversion of the pulsed laser output wavelength.

14. The method of claim 11, in which the pulse seed laser source includes a seed diode laser.

15. The method of claim 11, in which the pulse seed laser source includes a seed fiber laser.
